(19) United States
(12) Patent Application Publication
(10) Pub. No.: US 2017/0105030 A1
(43) Pub. Date: Apr. 13, 2017

(54) ACCESSIBILITY FOR LIVE-STREAMED CONTENT

(71) Applicant: International Business Machines Corporation, Armonk, NY (US)

(72) Inventors: Alexander J. Kelly, Romsey (GB); Alexander D.S. Mirski-Fitton, Chandlers Ford (GB); Edwin P.J. Moffatt, Hursley (GB); Ross B. Pavitt, Headley (GB)

(21) Appl. No.: 14/876,960

(22) Filed: Oct. 7, 2015

(51) Int. Cl. H04N 21/2343; H04N 21/485; H04N 21/4788; H04L 29/06; H04N 21/478

(52) U.S. Cl. CPC H04N 21/23439; H04L 65/60; H04N 21/4781; H04N 21/4788; H04N 21/4854; H04N 21/4852

(57) ABSTRACT

According to one embodiment, a method for improving accessibility to a plurality of live-streamed media content is provided. The method may include generating a plurality data corresponding to a media source, whereby the media source may be a video game engine, a teleconferencing program, or a television broadcast. A plurality of media streams may be created from the received plurality of data, whereby at least one media stream from the created plurality of media streams provides a unique setting, such as a color blind setting or a language setting. The created plurality of media streams may be transmitted to a receiving user. Additionally, at least one of the transmitted plurality of media streams may be enabled to be selected by the receiving user and displayed accordingly.

### BACKGROUND

The present invention relates generally to the field of computers, and more particularly to live streaming of media content.

Live streaming of content may refer to a real-time delivery method of source media over a distribution network. For example, a content provider may digitize and transmit the source media over the network. Accordingly, the source media may be constantly received by and presented to one or more viewers. News programs, sporting events, and video game play-through, among others, may be delivered to the viewers via a live stream.

### SUMMARY

According to one embodiment, a method for improving accessibility to a plurality of live-streamed media content is provided. The method may include generating a plurality of data corresponding to a media source. The method may also include creating a plurality of media streams from the received plurality of data, whereby at least one media stream within the created plurality of media streams is created based on a unique setting. The method may further include transmitting the created plurality of media streams to a receiving user.

According to another embodiment, a computer system for improving accessibility to a plurality of live-streamed media content is provided. The computer system may include one or more processors, one or more computer-readable memories, one or more computer-readable tangible storage devices, and program instructions stored on at least one of the one or more storage devices for execution by at least one of the one or more processors via at least one of the one or more memories, whereby the computer system is capable of performing a method. The computer system may include generating a plurality of data corresponding to a media source. The computer system may also include creating a plurality of media streams from the received plurality of data, whereby at least one media stream within the created plurality of media streams is created based on a unique setting. The computer system may further include transmitting the created plurality of media streams to a receiving user.

According to yet another embodiment, a computer program product improving accessibility to a plurality of live-streamed media content is provided. The computer program product may include one or more computer-readable storage devices and program instructions stored on at least one of the one or more tangible storage devices, the program instructions executable by a processor. The computer program product may include program instructions to generate a plurality of data corresponding to a media source. The computer program product may also include program instructions to create a plurality of media streams from the received plurality of data, whereby at least one media stream within the created plurality of media streams is created based on a unique setting. The computer program product may further include program instructions to transmit the created plurality of media streams to a receiving user.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 is an operational flowchart illustrating the steps carried out by a program that improves accessibility for live-streamed media content, according to at least one embodiment;

FIGS. 3A-3C are exemplary views of live-streamed media content according to at least one embodiment;

FIG. 4 is a block diagram of internal and external components of computers and servers depicted in FIG. 1 according to at least one embodiment;

FIG. 5 is a block diagram of an illustrative cloud computing environment including the computer system depicted in FIG. 1, according to at least one embodiment; and

FIG. 6 is a block diagram of functional layers of the illustrative cloud computing environment of FIG. 5, according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

Embodiments of the present invention relate generally to the field of computers, and more particularly to live streaming of media content. The following described exemplary embodiments provide a system, method and program product to, among other things, improve accessibility for live-streamed media content. Therefore, the present embodiment has the capacity to improve the technical field of live streaming of media content by enabling a user to select between multiple streams of media content. For example, a color blind user and a non-color blind user may be able to select, with respect to the live streaming of video games, a color blind accessible stream and a non-color blind accessible stream, respectively, to allow both such viewers to access the content in the appropriately selected color mode.

As previously described, live streaming of content may refer to a real-time delivery method of a source media over a distribution network. News programs, sporting events, teleconferencing, and video game play-through, among others, may be delivered to the viewers via a live stream. However, one or more viewers of the live stream may have, among other things, a visual impairment, such as color blindness, which may make it challenging to watch the live stream. Currently, a single video stream may be used to deliver the source media to visually impaired viewers. For example, video games, may provide a “color blind mode”, whereby the game engine may enhance the contrast between two colors (e.g., red and green). While color blind mode may allow color blind players to play the game, the content in the single live stream may accordingly be displayed in color blind mode which may be, among other things, less suitable for non-color blind viewers. Conversely, non-color blind players of video games that provide a color blind mode may transmit a single stream with color blind mode disabled, thus hindering the ability of color blind viewers to view the stream. As such, it may be advantageous, among other things, to transmit both a color blind accessible stream and a non-color blind accessible stream to allow both color blind viewers and non-color blind viewers to access the content in the appropriately selected color mode.

According to at least one implementation, the present embodiment may embed code into a media streaming client, such as a video game client, which may natively render the media stream in both standard and color blind mode. As such, the present embodiment may receive the multiple streams and broadcast them. Furthermore, the user may be enabled to select a preferred version of one of the streams to view. According to at least one implementation, the user may select the media stream via an internet browser. One advantage of the present embodiment is that a user may view the streamed media content in a browser-based thin client as opposed to watching the streamed media content in a rich standalone client. Additionally, the user may have the advantage of using the native color blind adjustments, as opposed to or in addition to adding adjustments in post-processing, included within the present embodiment. Although the present embodiment may be useful with respect to media content, such as video games, it may further apply to other streamed media environments. For example, the present embodiment may be utilized with respect to an online meeting, in which a screen is being used by multiple participants.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method and program product that improves accessibility for live-streamed media content. According to the present embodiment, accessibility for live-streamed media content may be provided through the transmission of multiple streams (i.e., the color-blind accessible media stream and the non-color blind accessible media stream), among others, to allow both color blind and non-color blind viewers to access the content in the appropriately selected color mode.

According to at least one implementation, the present embodiment may provide media streaming associated with live-streamed media content, in which color blind accessible and non-color blind accessible media streams may be created. More particularly, the present embodiment may utilize code associated with a media content provider, such as a video game streaming client, whereby a color blind accessible stream and a non-color blind accessible stream may be created from source media data, such as a video game rendering engine, and both streams may be transmitted to a user display.

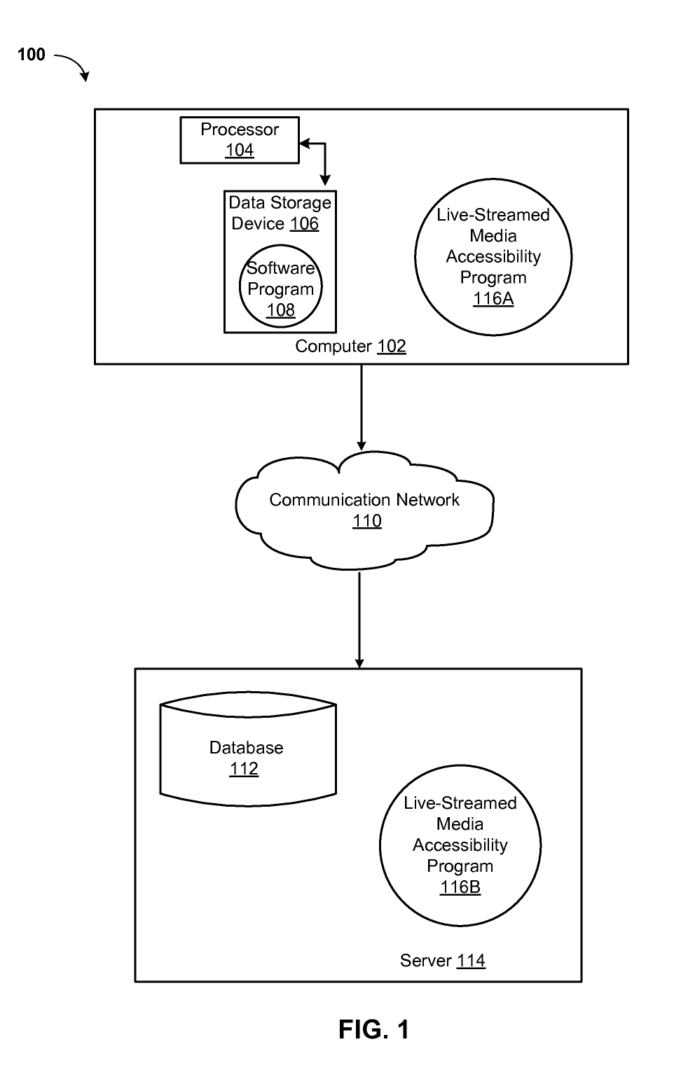

Referring to FIG. 1, an exemplary networked computer environment 100 in accordance with one embodiment is depicted. The networked computer environment 100 may include a computer 102 with a processor 104 and a data storage device 106 that is enabled to run a software program 108 and a Live-Streamed Media Accessibility Program 116A. The networked computer environment 100 may also include a server 114 that is enabled to run a Live-Streamed Media Accessibility Program 116B that may interact with a database 112 and a communication network 110. The networked computer environment 100 may include a plurality of computers 102 and servers 114, only one of which is shown. It should be appreciated that FIG. 1 provides only an illustration of one implementation and does not imply any limitations with regard to the environments in which different embodiments may be implemented. Many modifications to the depicted environments may be made based on design and implementation requirements.

Communications network 110 may allow the client computer 102 to communicate with the server computer 114. The communications network 110 may include connections, such as wire, wireless communication links, or fiber optic cables. The communication network 110 may include various types of communication networks, such as a wide area network (WAN), local area network (LAN), a telecommunication network, a wireless network, a public switched network and/or a satellite network.

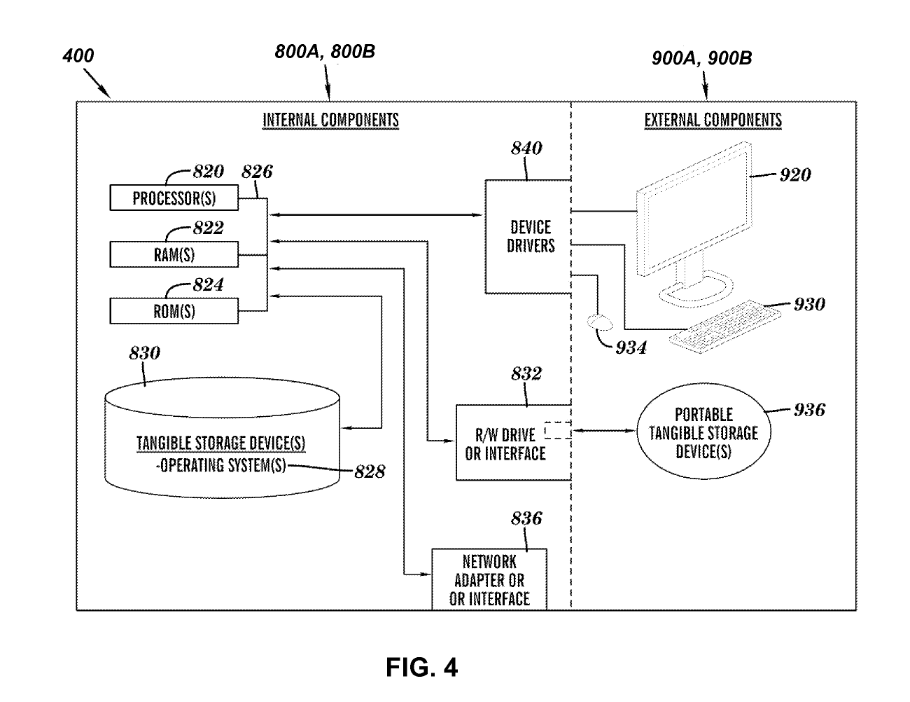

Computer 102 may be, for example, a mobile device, a telephone, a personal digital assistant, a netbook, a laptop computer, a tablet computer, a desktop computer, or any type of computing device capable of running a program and accessing a network. Computer 102 may be capable of hosting Live-Streamed Media Accessibility Program 116A, 116B, and communicating with server 114 via network 110, in accordance with one embodiment of the invention. As will be discussed with reference to FIG. 4, client computer 102 may include internal components 800B and external components 900B, respectively.

Server computer 114 may be a laptop computer, netbook computer, personal computer (PC), a desktop computer, or any programmable electronic device capable of hosting the Live-Streamed Media Accessibility Program 116B, and communicating with client computing device 102 and server computer 114 via network 110, in accordance with embodiments of the invention. As will be discussed with reference to FIG. 4, server computer 114 may include internal components 800A and external components 900A, respectively. Server 114 may also operate in a cloud computing service model, such as Software as a Service (SaaS), Platform as a Service (PaaS), or Infrastructure as a Service (IaaS). Server 114 may also be located in a cloud computing deployment model, such as a private cloud, community cloud, public cloud, or hybrid cloud.

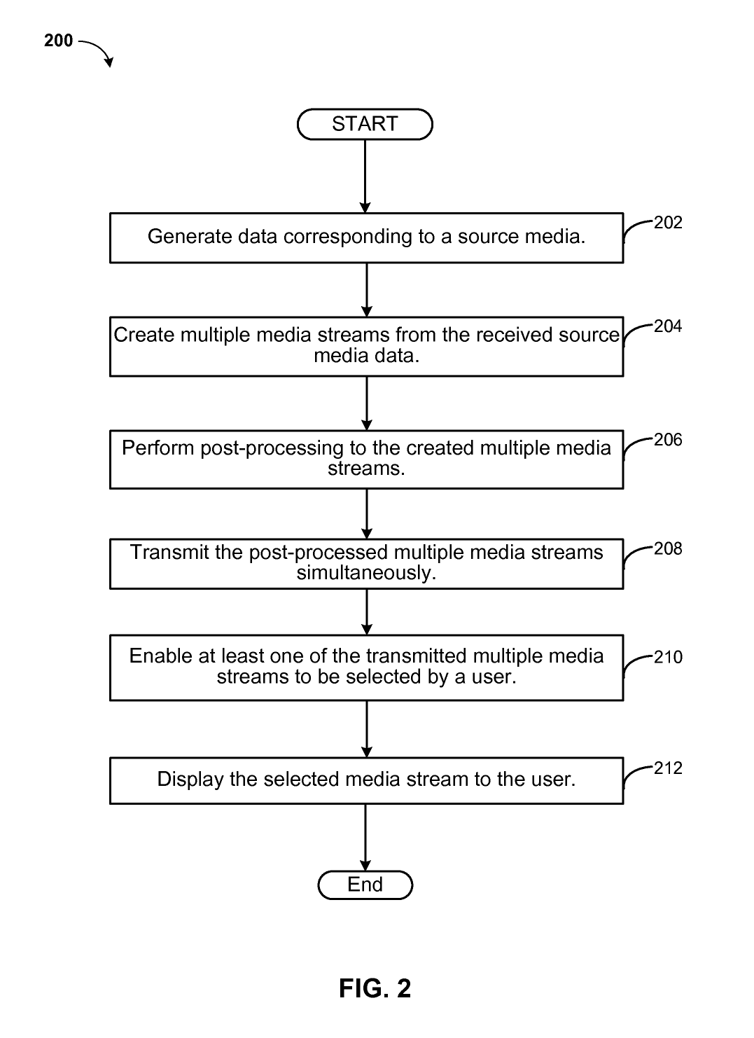

According to various implementations of the present embodiment, the Live-Streamed Media Accessibility Program 116A, 116B may be a program that produces source media capable of being rendered into multiple media streams for transmission and display on other client computing devices 102. In another embodiment of the present invention, the Live-Streamed Media Accessibility Program 116A, 116B may be an application programming interface (API) capable of rendering multiple media streams from source media generated by a program, such as a video game program or a virtual meeting presentation program. For example, a user using a client computer 102 may utilize the Live-Streamed Media Accessibility Program 116A, 116B to improve accessibility for live-streamed media content for users with a color blindness impairment or proficiency in a different language. Live-Streamed Media Accessibility Program 116A, 116B may interact with a database 112 that may be embedded in various storage devices, such as, but not limited to a computer/mobile device 102, a networked server 114, or a cloud storage service. The interaction with the database 112 may include, but is not limited to, storage of the media stream for later rebroadcast. The Live-Streamed Media Accessibility method is explained in more detail below with respect to FIG. 2.

Software program 108 may be a program on computer 102 capable of interacting with Live-Streamed Media Accessibility Program 116A, 116B. Computer 102 may include a plurality of software programs 108, only one of which is shown for illustrative brevity. Software program 108 may be stored in digital storage device 106. Software program 108 may be a media streaming program, such as XSplit® Broadcaster (XSplit Broadcaster and all XSplit Broadcaster-based trademarks and logos are trademarks or registered trademarks of SplitmediaLabs, Ltd. and/or its affiliates), capable of transmitting a media stream of user content to other users. Furthermore, software program 108 may be a program, such as a video game program, a teleconferencing program, or a slideshow presentation program.

Referring to FIG. 2, an operational flowchart 200 illustrating the steps carried out by a program that provides accessibility for live-streamed media content in accordance with one embodiment is depicted. FIG. 2 may be described with the aid of the exemplary embodiment of FIG. 1. As previously described, the Live-Streamed Media Accessibility Program 116A, 116B (FIG. 1) may improve accessibility for live-streamed media content through the creation of multiple media streams.

At 202, Live-Streamed Media Accessibility Program 116A, 116B (FIG. 1) generates source media data. For example, in the case of live-streaming of video games, the data may be generated by a video game rendering engine. Alternatively, in the case of teleconferencing or televised broadcasts, the data may be generated by a teleconferencing program or television service, respectively. In one exemplary embodiment, a Live-Streamed Media Accessibility Program 116A (FIG. 1) running on a computer 102 (FIG. 1) may be an API within a software program 108 (FIG. 1), such as a video game program, that generates the source media. In another exemplary embodiment, Live-Streamed Media Accessibility Program 116A, 116B (FIG. 1) may be a standalone program that receives source media data from a separate standalone software program 108 (FIG. 1).

At 204, Live-Streamed Media Accessibility Program 116A, 116B (FIG. 1) creates multiple media streams from the generated source media data. Live-Streamed Media Accessibility Program 116A, 116B (FIG. 1) may create the multiple media streams based on unique settings. The unique settings may include any user selectable options within a program options menu, such as color blind viewing, language settings, graphical effects, and sound quality. For example, Live-Streamed Media Accessibility Program 116A, 116B (FIG. 1) may generate a color blind accessible stream and a non-color blind accessible stream from the received source media data. Furthermore, a first stream with on-screen elements (e.g., characters, background, items, heads-up display, menus, etc.) in a first language and a second stream with on-screen elements in a second language may be created. For example, Live-Streamed Media Accessibility Program 116A, 116B (FIG. 1) may generate a media stream with on-screen elements display in English as well as a second media stream with on-screen elements displayed in Russian.

At 206, Live-Streamed Media Accessibility Program 116A, 116B (FIG. 1) performs post-processing of the created multiple media streams. By way of example and not of limitation, the post-processing elements may include textual or graphical overlays, watermarks, color-correction, or an audiovisual recording of a user associated with the source media. For example, a user streaming video game content may wish to include a webcam view of the user's face as well as a tally of donations received from viewers. Therefore, Live-Streamed Media Accessibility Program 116A, 116B (FIG. 1) may include the webcam and donation counter as overlays on the multiple media streams. Live-Streamed Media Accessibility Program 116A, 116B (FIG. 1) may determine the specific post-processing elements to include in the multiple media streams based on user preferences. Alternatively, a standalone software program 108 (FIG. 1) capable of adding post-processing elements to streamed media, such as XSplit® Broadcaster (XSplit Broadcaster and all XSplit Broadcaster-based trademarks and logos are trademarks or registered trademarks of SplitmediaLabs, Ltd. and/or its affiliates), may be implemented by Live-Streamed Media Accessibility Program 116A, 116B (FIG. 1) when performing post processing of the multiple media streams. In operation, the data storage device 106 (FIG. 1) on the computer 102 (FIG. 1) may contain one or more post-processing elements to be added to the multiple media streams. Alternatively, the database 112 (FIG. 1) on the server 114 (FIG. 1) may contain the post-processing elements.

At 208, Live-Streamed Media Accessibility Program 116A, 116B (FIG. 1) transmits the post-processed multiple media streams simultaneously. It may be appreciated that the multiple media streams may be in a form substantially the same or similar to a stream as may be seen by a receiving user. Additionally, Live-Streamed Media Accessibility Program 116A, 116B (FIG. 1) may implement data compression methods on the multiple media streams before transmission of the multiple media streams. In one exemplary embodiment, Live-Streamed Media Accessibility Program 116A (FIG. 1) on the computer 102 (FIG. 1) may transmit the post-processed multiple media streams to the server 114 (FIG. 1) via the communication network 110 (FIG. 1). In another exemplary embodiment, Live-Streamed Media Accessibility Program 116B (FIG. 1) on server 114 (FIG. 1) may alternatively transmit the post-processed multiple media streams to one or more client computers 102 (FIG. 1) via the communication network 110 (FIG. 1). As previously described, the networked computer environment 100 (FIG. 1) may include a plurality of computers 102 (FIG. 1), only one of which is shown.

At 210, Live-Streamed Media Accessibility Program 116A, 116B (FIG. 1) enables at least one of the transmitted multiple media streams to be selected by a receiving user. The receiving user may select one or more streams from among the transmitted streams using, for example, a graphical user interface (GUI). In operation, Live-Streamed Media Accessibility Program 116A (FIG. 1) on the client computer 102 (FIG. 1) may allow the receiving user to select at least one stream from among the plurality of multiple media streams transmitted from the server 114 (FIG. 1) via communication network 110 (FIG. 1). Alternatively, Live-Streamed Media Accessibility Program 116A (FIG. 1) may request a single media stream from Live-Streamed Media Accessibility Program 116B (FIG. 1) on the server 114 (FIG. 1) and receive the requested media stream.

At 212, Live-Streamed Media Accessibility Program 116A, 116B (FIG. 1) displays the selected media stream to the receiving user. It may be appreciated that the media stream as selected by the receiving user may be displayed in any format. In operation, Live-Streamed Media Accessibility Program 116A (FIG. 1) on the client computer 102 (FIG. 1) may display a user selected stream from among the multiple media streams transmitted by the server 114 (FIG. 1). Alternatively, Live-Streamed Media Accessibility Program 116A (FIG. 1) may display the single media stream received from the server 114 (FIG. 1).

It may be appreciated that FIG. 2 provides only an illustration of one implementation and does not imply any limitations with regard to how different embodiments may be implemented. Many modifications to the depicted environments may be made based on design and implementation requirements. As previously mentioned, Live-Streamed Media Accessibility Program 116A, 116B (FIG. 1) may enable viewers to switch between a color blind accessible mode and a non-color blind accessible mode. However, the accessibility method as described herein with respect to the present embodiment may further be used to provide the ability to display on-screen elements of a media stream (i.e., characters, backgrounds, items, heads-up displays, menus, etc.) in multiple languages (e.g., English, Japanese, Russian, etc.) and enable viewers to switch between these languages. Furthermore, Live-Streamed Media Accessibility Program 116A, 116B (FIG. 1) may allow the creation of multiple media streams containing various elements selectable by users within an options menu. For example, an options menu may contain a particle effects option. Therefore, Live-Streamed Media Accessibility Program 116A, 116B (FIG. 1) may create multiple media streams according to the selected particle effects. When a partially sighted receiving user selects to disable particle effects, Live-Streamed Media Accessibility Program 116A, 116B (FIG. 1) may display the media stream associated with the disabled particle effects, which may clear up visual noise for the receiving viewer.

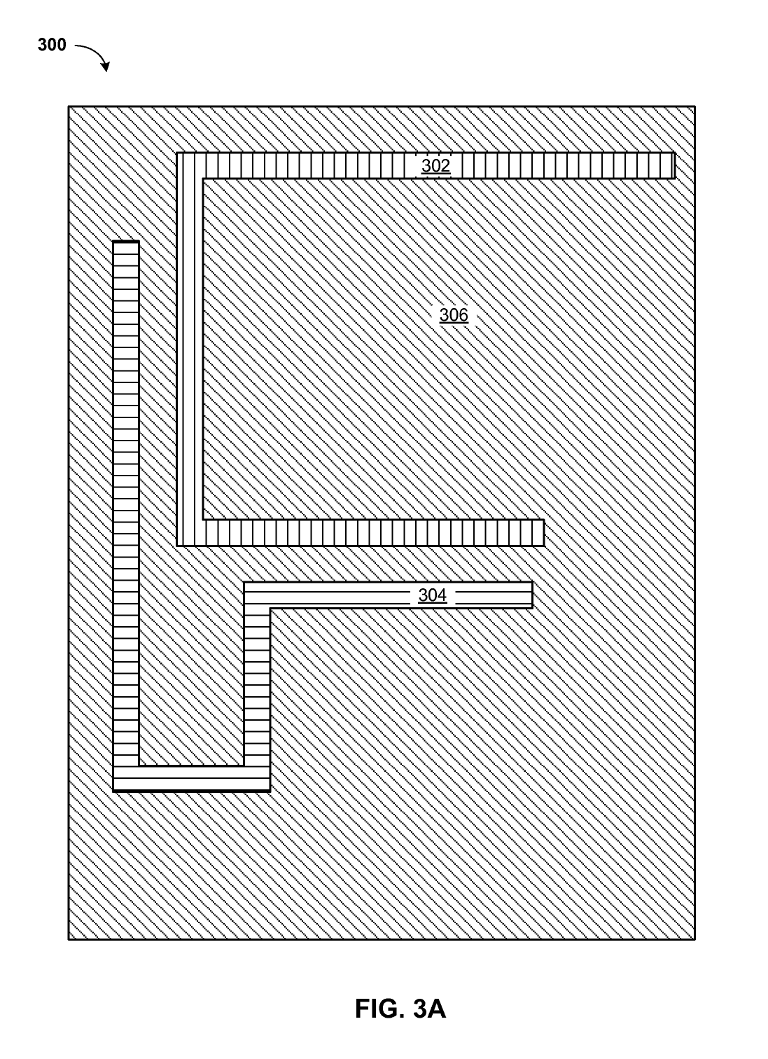

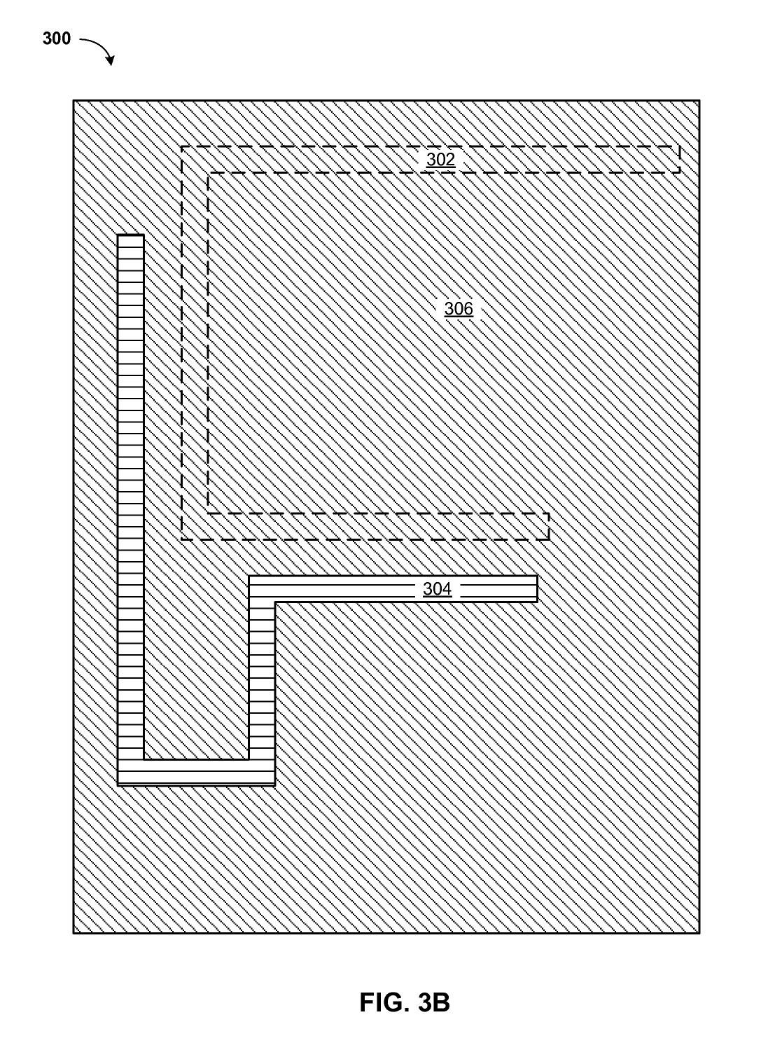

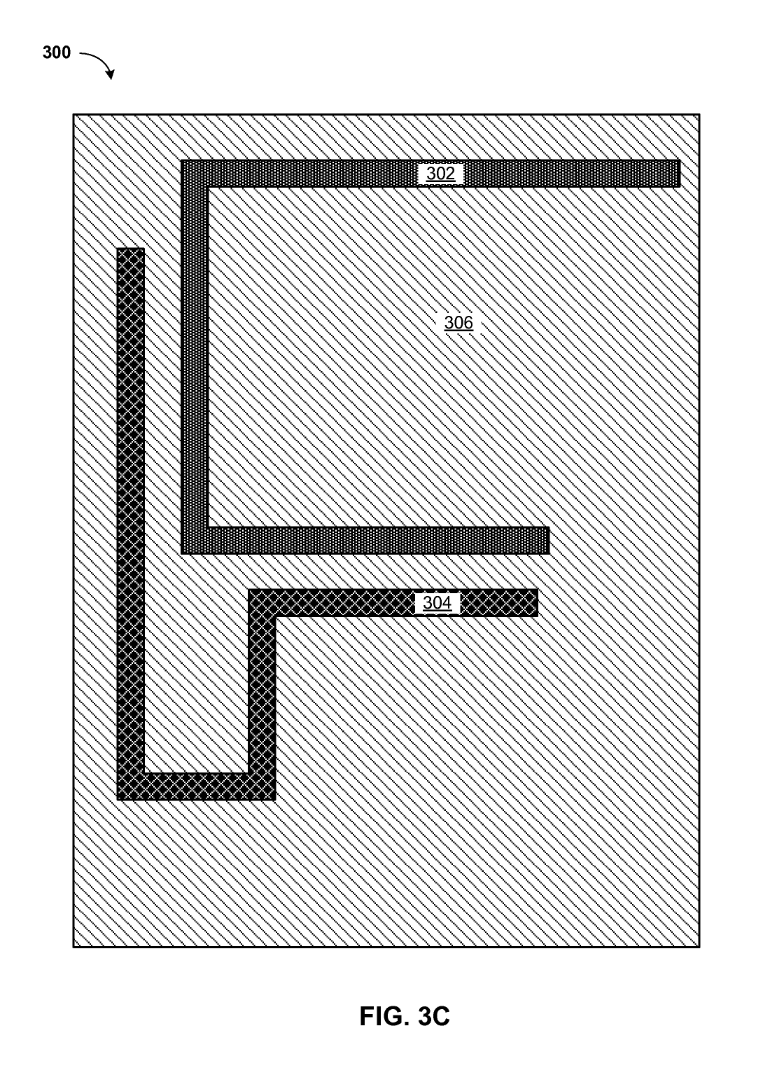

Referring to FIGS. 3A-3C, exemplary views 300 of live-streamed media content in accordance with one embodiment are depicted. With respect to FIG. 3A, an exemplary view non-color blind accessible media stream is depicted. Using common rendering techniques, a single media stream may display a stream using, among other things, several colors. For example, a video game engine may render a first character 302 and a second character 304 onto a background 306. In a non-color blind accessible stream, the first character 302 may be rendered in a first color, such as red, while the second character 304 may be rendered in a second color, such as blue. Additionally, the background 306 may be rendered in a third color, such as green. It may be appreciated, however, that the media stream may render the elements 302-306 (i.e., characters, backgrounds, items, heads-up displays, etc.) of the media stream in any color.

Referring to FIG. 3B, an exemplary view of a non-color blind accessible stream as may be viewed by a color blind person in accordance with one embodiment is depicted. As previously described, one or more colors of the stream (i.e., red and green) may be indistinguishable to a color blind viewer. For example, a color blind viewer may be unable to distinguish the first character 302 from the background 306 due to, for example, red-green color blindness. As such, the color blind viewer may be able to view the second character 304 on the background 306 but may be unable to view the first character 302 on the background 306. Alternatively, the first character 302 and the second character 304 may be rendered in colors that may be, among other things, indistinguishable with respect to each other. For example, the first character 302 may be rendered in green, while the second character 304 may be rendered in red. Thus, the color blind viewer may misidentify the first character 302 and the second character 304.

Referring to FIG. 3C, an exemplary view of a color blind accessible stream in accordance with one embodiment is depicted. Using common rendering techniques, a color blind accessible media stream may, among other things, substitute an indistinguishable color for a distinguishable color (e.g., substituting green with cyan) to enable a color blind viewer to see all elements of the media stream. Alternatively, the color blind accessible media stream may substitute an indistinguishable color for a pattern or texture (e.g. cross-hatching, dithering, etc.) of multiple colors having higher contrast. For example, in a color blind accessible stream, the first character 302 may be rendered in a first texture, such as black and white dithering, while the second character 304 may be rendered in a second texture, such as black and white cross-hatching. Additionally, the background 306 may be rendered in a color, such as green. It may be appreciated, however, that the media stream may render the elements 302-306 (i.e., characters, backgrounds, items, heads-up displays, etc.) of the media stream in any color, pattern, or texture. Live-Streamed Media Accessibility Program 116A, 116B (FIG. 1) may allow a user to select a stream that best fits the user's visual preference. As such, a color blind viewer of a selected media stream may now be able to distinguish the second character 304 from the background 306 and, thus, be able to view all elements 302-306 of the media stream.

FIG. 4 is a block diagram 400 of internal and external components of computers depicted in FIG. 1 in accordance with an illustrative embodiment of the present invention. It should be appreciated that FIG. 4 provides only an illustration of one implementation and does not imply any limitations with regard to the environments in which different embodiments may be implemented. Many modifications to the depicted environments may be made based on design and implementation requirements.

Data processing system 800, 900 is representative of any electronic device capable of executing machine-readable program instructions. Data processing system 800, 900 may be representative of a smart phone, a computer system, PDA, or other electronic devices. Examples of computing systems, environments, and/or configurations that may be represented by data processing system 800, 900 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 (FIG. 1) and network server 114 (FIG. 1) may include respective sets of internal components 800A,B and external components 900A,B illustrated in FIG. 4. Each of the sets of internal components 800 include one or more processors 820, one or more computer-readable RAMs 822 and one or more computer-readable ROMs 824 on one or more buses 826, and one or more operating systems 828 and one or more computer-readable tangible storage devices 830. The one or more operating systems 828 and the Software Program 108 (FIG. 1) and the Live-Streamed Media Accessibility Program 116A (FIG. 1) in client computer 102 (FIG. 1) and the Live-Streamed Media Accessibility Program 116B (FIG. 1) in network server 114 (FIG. 1) are stored on one or more of the respective computer-readable tangible storage devices 830 for execution by one or more of the respective processors 820 via one or more of the respective RAMs 822 (which typically include cache memory). In the embodiment illustrated in FIG. 4, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800A,B also includes a R/W drive or interface 832 to read from and write to one or more portable computer-readable tangible storage devices 936 such as a CD-ROM, DVD, memory stick, magnetic tape, magnetic disk, optical disk or semiconductor storage device. A software program, such as the Software Program 108 (FIG. 1) and the Live-Streamed Media Accessibility Program 116A, 116B (FIG. 1) can be stored on one or more of the respective portable computer-readable tangible storage devices 936, read via the respective R/W drive or interface 832 and loaded into the respective hard drive 830.

Each set of internal components 800A,B also includes network adapters or interfaces 836 such as a TCP/IP adapter cards, wireless Wi-Fi interface cards, or 3G or 4G wireless interface cards or other wired or wireless communication links. The Software Program 108 (FIG. 1) and the Live-Streamed Media Accessibility Program 116A (FIG. 1) in client computer 102 (FIG. 1) and the Live-Streamed Media Accessibility Program 116B (FIG. 1) in network server 114 (FIG. 1) can be downloaded to client computer 102 (FIG. 1) and network server 114 (FIG. 1) from an external computer via a network (for example, the Internet, a local area network or other, wide area network) and respective network adapters or interfaces 836. From the network adapters or interfaces 836, the Software Program 108 (FIG. 1) and the Live-Streamed Media Accessibility Program 116A (FIG. 1) in client computer 102 (FIG. 1) and the Live-Streamed Media Accessibility Program 116B (FIG. 1) in network server 114 (FIG. 1) are loaded into the respective hard drive 830. The network may comprise copper wires, optical fibers, wireless transmission, routers, firewalls, switches, gateway computers and/or edge servers.

Each of the sets of external components 900A,B can include a computer display monitor 920, a keyboard 930, and a computer mouse 934. External components 900A,B can also include touch screens, virtual keyboards, touch pads, pointing devices, and other human interface devices. Each of the sets of internal components 800A,B also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

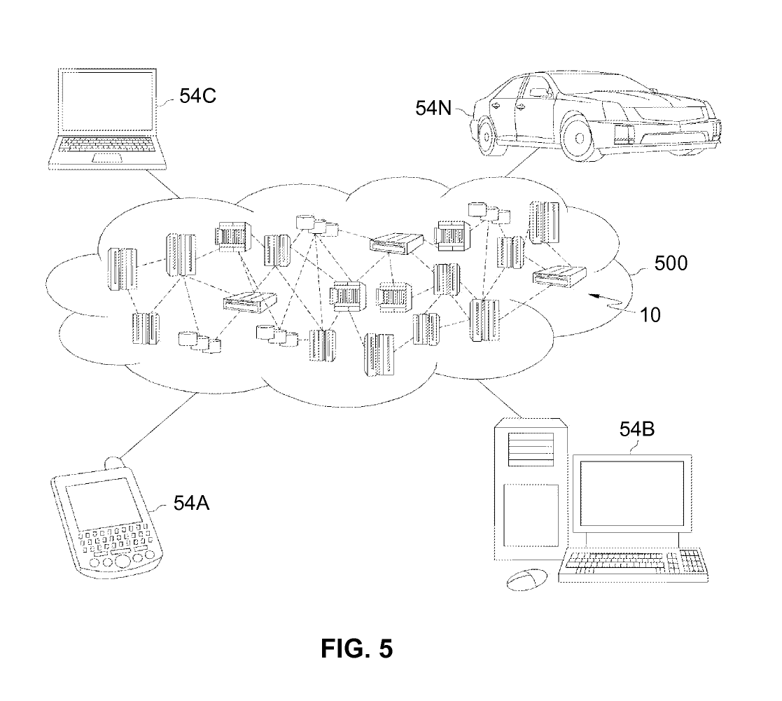

Referring to FIG. 5, illustrative cloud computing environment 500 is depicted. As shown, cloud computing environment 500 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 500 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 500 can communicate with any type of computerized device over any type of network and/or network addressable connection (e.g., using a web browser).

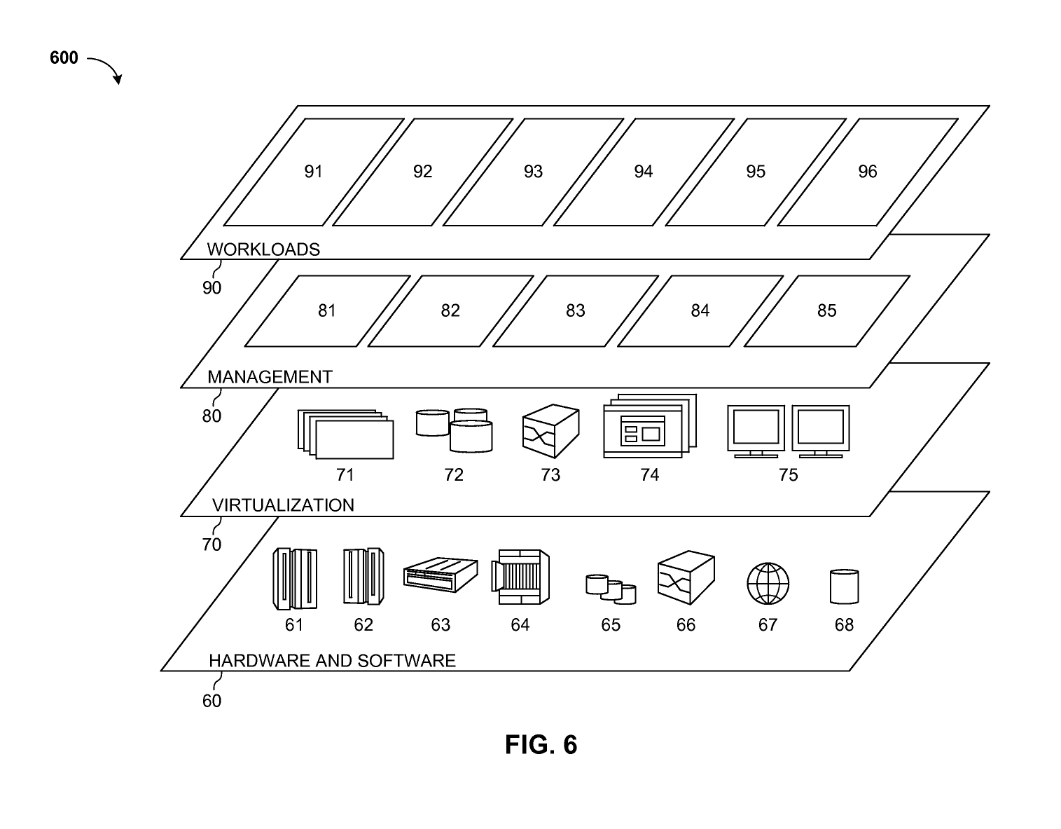

Referring to FIG. 6, a set of functional abstraction layers 600 provided by cloud computing environment 500 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and Live-Streamed Media Accessibility 96. Live-Streamed Media Accessibility 96 may provide one or media streams to improve accessibility for live-streamed media content.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

1. A processor-implemented method for improving accessibility to a plurality of live-streamed media content, comprising:
generating, by a processor, a plurality of live-streamed source media data corresponding to a plurality of user interactions with a video game program;
creating a plurality of media streams from the generated plurality of live-streamed source media data, wherein a first media stream within the created plurality of media streams is a colorblind accessible stream, and wherein a second media stream within the plurality of created media streams is a non-colorblind accessible stream, and wherein the colorblind accessible stream substitutes at least one color depicted in the non-colorblind media stream with a more distinguishable color to a person with a colorblindness or a texture, and wherein the texture is selected from a group consisting of cross-hatching and dithering; and
transmitting the created plurality of media streams to a receiving user.

2. The method of claim 1, further comprising:
enabling at least one of the transmitted plurality of media streams to be selected by the receiving user.

3. The method of claim 2, further comprising:
displaying the at least one selected media stream to the receiving user.

4. The method of claim 1, wherein the received media source comprises at least one of a video game engine, a teleconferencing program, and a television broadcast.

5. The method of claim 1, further comprising:
performing post-processing on the created plurality of media streams.

6. The method of claim 5, wherein performing post-processing comprises at least one of adding a graphical overlay, a textual overlay, a watermark, and an audiovisual recording of a sending user associated with the media source.

7. The method of claim 1, wherein the plurality of media streams comprises at least one of a color blind accessible media stream, a non-color blind accessible media stream, a media stream having one or more on-screen elements in a first language, a media stream having one or more on-screen elements in a second language, and a media stream having one or more qualities selectable from an options menu.

8. The method of claim 1, wherein the first media stream includes a plurality of on-screen elements displayed in a first language and the second media stream includes the plurality of on-screen elements displayed in a second language, and wherein the plurality of on-screen elements includes a plurality of characters, a background, a heads-up display, and a plurality of menus.

9. A computer system for improving accessibility to a plurality of live-streamed media content, comprising:
one or more processors, one or more computer-readable memories, one or more computer-readable tangible storage devices, and program instructions stored on at least one of the one or more storage devices for execution by at least one of the one or more processors via at least one of the one or more memories, wherein the computer system is capable of performing a method comprising:
generating a plurality of live-streamed source media data corresponding to a plurality of user interactions with a video game program;
creating a plurality of media streams from the generated plurality of live-streamed source media data, wherein a first media stream within the created plurality of media streams is a colorblind accessible stream, and wherein a second media stream within the plurality of created media streams is a non-colorblind accessible stream, and wherein the colorblind accessible stream substitutes at least one color depicted in the non-colorblind media stream with a more distinguishable color to a person with a colorblindness or a texture, and wherein the texture is selected from a group consisting of cross-hatching and dithering; and
transmitting the created plurality of media streams to a receiving user.

10. The computer system of claim 9, further comprising:
enabling at least one of the transmitted plurality of media streams to be selected by the receiving user.

11. The computer system of claim 10, further comprising:
displaying the at least one selected media stream to the receiving user.

12. The computer system of claim 9, wherein the received media source comprises at least one of a video game engine, a teleconferencing program, and a television broadcast.

13. The computer system of claim 9, further comprising:
performing post-processing on the created plurality of media streams.

14. The computer system of claim 13, wherein performing post-processing comprises at least one of adding a graphical overlay, a textual overlay, a watermark, and an audiovisual recording of a sending user associated with the media source.

15. The computer system of claim 9, wherein the plurality of media streams comprises at least one of a color blind accessible media stream, a non-color blind accessible media stream, a media stream having one or more on-screen elements in a first language, a media stream having one or more on-screen elements in a second language, and a media stream having one or more qualities selectable from an options menu.

16. A computer program product for improving accessibility to a plurality of live-streamed media content, comprising:
one or more computer-readable storage devices and program instructions stored on at least one of the one or more tangible storage devices, the program instructions executable by a processor, the program instructions comprising:
program instructions to generate a plurality of live-streamed source media data corresponding to a plurality of user interactions with a video game program;
program instructions to create a plurality of media streams from the generated plurality of live-streamed source media data, wherein a first media stream within the created plurality of media streams is a colorblind accessible stream, and wherein a second media stream within the plurality of created media streams is a non-colorblind accessible stream, and wherein the colorblind accessible stream substitutes at least one color depicted in the non-colorblind media stream with a more distinguishable color to a person with a colorblindness or a texture, and wherein the texture is selected from a group consisting of cross-hatching and dithering; and
program instructions to transmit the created plurality of media streams to a receiving user.

17. The computer program product of claim 16, further comprising:
program instructions to enable at least one of the transmitted plurality of media streams to be selected by the receiving user; and
program instructions to display the at least one selected media stream to the receiving user.

18. The computer program product of claim 16, further comprising:
program instructions to performing post-processing on the created plurality of media streams.

19. The computer program product of claim 17, wherein performing post-processing comprises at least one of adding a graphical overlay, a textual overlay, a watermark, and an audiovisual recording of a sending user associated with the media source.

20. The computer program product of claim 16, wherein the plurality of media streams comprises at least one of a color blind accessible media stream, a non-color blind accessible media stream, a media stream having one or more on-screen elements in a first language, a media stream having one or more on-screen elements in a second language, and a media stream having one or more qualities selectable from an options menu.
